(19) United States
(12) Patent Application Publication
(10) Pub. No.: US 2025/0238694 A1
(43) Pub. Date: Jul. 24, 2025

(54) LARGE LANGUAGE MODEL INFERENCE BY PIGGYBACKING DECODES WITH CHUNKED PREFILLS

(71) Applicant: Microsoft Technology Licensing, LLC, Redmond, WA (US)

(72) Inventors: Jayashree MOHAN, Bengaluru (IN); Ashish PANWAR, Bengaluru (IN); Nipun KWATRA, Bangalore (IN); Bhargav GULAVANI, Bangalore (IN); Ramachandran RAMJEE, Bangalore (IN); Amey AGRAWAL, Atlanta, GA (US)

(73) Assignee: Microsoft Technology Licensing, LLC, Redmond, WA (US)

(21) Appl. No.: 18/416,564

(22) Filed: Jan. 18, 2024

(51) Int. Cl. G06N 5/046; G06N 3/0895

(52) U.S. Cl. CPC G06N 5/046; G06N 3/0895

(57) ABSTRACT

The present disclosure relates to methods and systems that use chunked prefills and decode-maximal batching for large language model (LLM) inference. The methods and systems split a prefill request for LLM inference into equal sized prefill chunks. The methods and systems use decode-maximal batching to construct a hybrid batch by using a single prefill chunk and filling the remaining batch with decodes. The methods and systems provide the hybrid batches to a processing unit for processing.

### BACKGROUND

Large Language Model (LLM) inference consists of two distinct phases, a prefill phase which processes the input prompt and a decode phase which generates output tokens autoregressively. While the prefill phase effectively saturates graphics processing unit (GPU) compute at small batch sizes, the decode phase results in low compute utilization as the decode phase generates one token at a time per request. The varying prefills and decode times lead to imbalances across micro-batches when using pipeline-parallelism, resulting in further GPU inefficiencies due to pipeline bubbles.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Some implementations relate to a method. The method includes receiving, at a large language model (LLM), an input prompt for LLM inference. The method includes dividing the input prompt into a plurality of prefill chunks. The method includes creating a plurality of hybrid batches, wherein each hybrid batch includes a prefill chunk and at least one decode. The method includes providing the plurality of hybrid batches to a processing unit for processing the LLM inference.

Some implementations relate to a device. The device includes a processor; memory in electronic communication with the processor; and instructions stored in the memory, the instructions being executable by the processor to: receive, at a large language model (LLM), an input prompt for LLM inference; divide the input prompt into a plurality of prefill chunks; create a plurality of hybrid batches, wherein each hybrid batch includes a prefill chunk and at least one decode; and provide the plurality of hybrid batches to a processing unit for processing the LLM inference.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for using LLMs to perform LLM inference in accordance with implementations of the present disclosure.

FIG. 2 illustrates an example of dividing a prefill into a plurality of prefill chunks for performing LLM inference in accordance with implementations of the present disclosure.

FIG. 3 illustrates an example graph illustrating a prefill chunk size threshold in accordance with implementations of the present disclosure.

FIG. 4 illustrates an example of an LLM using hybrid batches for LLM inference in accordance with implementations of the present disclosure.

FIG. 5A illustrates an example of scheduling prefills and decodes across multiple GPUs using pipeline parallelism.

FIG. 5B illustrates an example of scheduling prefill chunks of uniform size and hybrid batches across multiple GPUs using pipeline parallelism in accordance with implementations of the present disclosure.

FIG. 6 illustrates an example method for using hybrid batches for LLM inference in accordance with implementations of the present disclosure.

FIG. 7 illustrates an example graph illustrating decode speedup in processing different batch sizes using hybrid batches in accordance with implementations of the present disclosure.

FIG. 8 illustrates an example graph illustrating an increase in throughput when using hybrid batches in accordance with implementations of the present disclosure.

FIG. 9 illustrates example graphs illustrating a reduction in pipeline bubbles when using hybrid batches of uniform size and pipeline parallelism across multiple GPUs in accordance with implementations of the present disclosure.

### DETAILED DESCRIPTION

This disclosure generally relates to LLM inference. The scaling up of language models has led to the use of LLMs in a variety of tasks, such as, natural language processing, question answering, code generation, etc. The use of LLMs across applications (e.g., conversational engines, search, code assistance, etc.) has significantly increased, resulting in an increase in GPU compute used to support LLM inference and LLM inference is becoming a dominant GPU workload.

Each LLM inference request goes through two phases (1) a prefill phase corresponding to the processing of the input prompt and (2) a decode phase which corresponds to the autoregressive token generation. The prefill phase processes all tokens in the input sequence in parallel, leading to high GPU utilization even with a small batch size. For example, on an A6000 GPU, for the LLaMA-13B model, a prefill with a sequence length of 512 tokens saturates GPU compute even at a batch size of just one. The decode phase, on the other hand, processes only a single token in each autoregressive pass, resulting in very low GPU utilization at low batch sizes. For example, at small batch sizes, the decode cost per token can be as high as 200 times the prefill cost per token. Moreover, since a request goes through only a single prefill pass, but multiple decode passes (one for each generated token), the overall inference efficiency of the GPU is significantly impacted. LLM inference inefficiency occurs due to: 1) suboptimal GPU utilization due to lack of parallelism and memory-bound nature of decode phase, and 2) significant pipeline bubbles due to inconsistent prefill and decode times across different iterations, leading to micro-batch imbalance.

As the model sizes of LLMs increase, it becomes necessary to scale the LLMs to multi-GPU as well as multi-node deployments. In servers with high bandwidth connectivity such as NVIDIA DGX A100, tensor-parallelism can enable deployment of an LLM on up to 8 GPUs, thereby supporting large batch sizes and efficient decode. LLM inference throughput, specifically that of the decode phase is limited by the maximum batch size that can fit on a GPU. LLM inference efficiency can benefit from model-parallelism, which shards the model weights across multiple GPUs freeing up memory to support larger batch sizes. Multi-node deployments can still lead to pipeline bubbles due to the unique characteristics of LLM inference. Specifically, LLM inference consists of a mixture of varying length prefills and decodes. This creates varying processing times for the different micro-batches, resulting in significant pipeline bubbles and wasted GPU-cycles.

The present disclosure provides systems and methods that uses chunked prefills and decode-maximal batching for LLM inference. Chunked prefills splits a prefill request for LLM inference into equal sized chunks and decode-maximal batching constructs a hybrid batch using a single prefill chunk and populates the remaining slots with decodes. During LLM inference, the prefill chunk saturates GPU compute, while the decode requests piggyback (e.g., added to the prefill in the batch) and cost up to an order of magnitude less compared to a decode-only batch. Chunked-prefills allows constructing multiple decode-maximal batches from a single prefill request, maximizing coverage of decodes that can piggyback. Furthermore, the uniform compute design of these batches ameliorates the imbalance between micro-batches, significantly reducing pipeline bubbles in the GPU. The present disclosure includes a number of practical applications that provide benefits and/or solve problems associated with LLM inference. Examples of these applications and benefits are discussed in further detail below.

The systems and methods use decode-maximal batching to construct a hybrid batch by using a single prefill chunk and filling the remaining batch with decodes. The systems and methods artificially increase the number of prefill iterations by splitting the prefill into a number of equal sized prefill chunks and filling the remaining batch with decodes. The hybrid batch provides units of work that are both compute saturating and have a uniform compute requirement, thereby addressing the problems of inefficient decodes in the GPU and pipeline bubbles in the GPU. Since prefill and decode phases have different compute requirements, by mixing the prefill and decode requests in a single batch enables uniformly high compute utilization in the GPU. Each request has only a single prefill phase, followed by multiple decode phases (for each generated token). Chunked-prefills allows multiple hybrid batches from a single prefill request, thereby increasing the coverage of decodes that can piggyback with a prefill.

In a hybrid batch, the single prefill chunk ensures high GPU utilization, while the decode phase requests piggyback along. The systems and methods select a prefill chunk size that maximizes the overall performance. In some implementations, the systems and methods use an average prefill-to-decode token ratio for an LLM application in determining the prefill chunk size. In some implementations, the systems and methods use pipeline parallelism or tensor parallelism for the chunked prefills and decode-maximal batching which aids in reducing pipeline bubbles.

One technical advantage of the systems and methods of the present disclosure is improvement in LLM inference performance. Decode-maximal batching improves GPU utilization by piggybacking decodes with prefills, which converts the memory-bound decode phase to be compute bound. Chunked-prefills helps with making more prefills available for decodes to piggyback, and also provides for a uniform unit of work which helps significantly reduce pipeline bubbles. For example, the systems and methods of the present disclosure when using a LLaMA-13B model on A6000 GPU improve the decode throughput by up to 10× (ten times) and accelerates end-to-end throughput by up to 1.33×. Another example includes using a LLaMa-33B on A100 GPU, and the systems and methods of the present disclosure achieve 1.25× higher end-to-end-throughput and up to 4.25× higher decode throughput.

Another technical advantage of the systems and methods of the present disclosure is efficient scaling of LLM inference across multiple GPUs in a cluster. By having uniform compute units, the LLM inference is able to scale to multiple nodes in a cluster while reducing pipeline bubbles and improving throughput of the LLM inference.

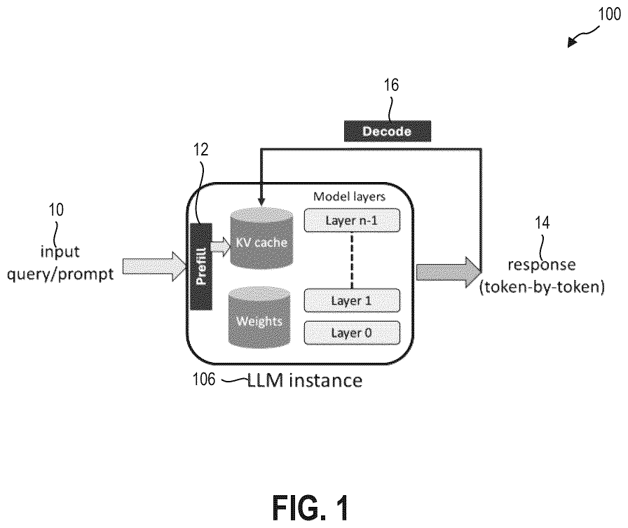

Referring now to FIG. 1, illustrated is an example environment 100 for performing LLM inference. LLM inference is when an LLM 106 generates predictions or responses based on an input prompt 10 provided to the LLM 106. The environment 100 includes a computing device with one or more LLMs 106 in communication with one or more processing units. The processing unit performs the compute required for the LLM inference and stores the values computed in memory of the processing unit. In some implementations, the processing unit is a central processing unit (CPU). In some implementations, the processing unit is an application specific integrated circuit (ASIC). In some implementations, the processing unit is one or more GPUs up to n GPUs, where n is a positive integer.

The LLM 106 receives an input prompt 10 from a user and performs LLM inference on the input prompt 10. In some implementations, a plurality of users may be in communication with the LLM(s) 106 providing input prompts 10 to the LLM(s) 106. The LLM(s) 106 include a plurality of layers and transformer decoder blocks where each decoder block consists of two primary modules: self-attention and feed-forward network (FFN). The decoder block modules perform operations, such as, layer normalization, activation functions, residual connections, etc.

Each LLM inference request goes through a prefill phase 12 corresponding to the processing of the input prompt 10 and a decode phase 16 which corresponds to the autoregressive token generation. The prefill phase 12 processes all tokens in the input sequence in parallel and applies the weights to the input prompt 10.

The decode phase 16 performs the same operations as prefill, but only for the single token which was generated in the last autoregressive iteration, and outputs a response 14 token-by-token. The computation for each new token depends on the key (K) and value (V) of all prior tokens in every iteration. In some implementations, a KV cache is implemented in GPU memory to cache the results of prior computations to avoid recomputing K and V of all tokens in every iteration and reducing an amount of computation required when running in a loop.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. In some implementations, the one or more computing devices are implemented in the cloud. In some implementations, the one or more computing devices are implemented on an edge device.

The features and functionalities discussed herein in connection with the various systems may be implemented on one computing device or across multiple computing devices. For example, the LLM(s) 106 and the processing unit(s) are implemented wholly on a computing device. Another example includes one or more subcomponents of the LLM(s) 106 and/or the processing unit(s) implemented across multiple computing devices. Moreover, in some implementations, one or more subcomponent of the LLM(s) 106 and the processing unit(s) may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation.

In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

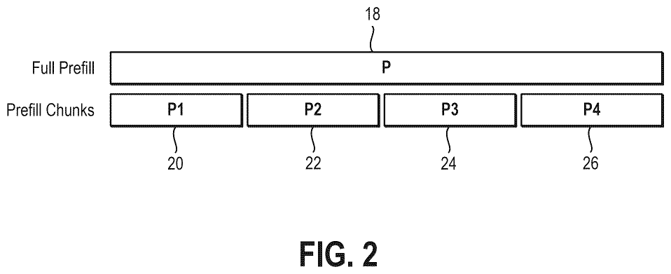

Referring now to FIG. 2, illustrated is an example of the LLM 106 (FIG. 1) using prefill chunks 20, 22, 24, 26 for performing LLM inference. The prefill 18 for an input prompt 10 (FIG. 1) is equal to the size of the input prompt 10. For example, the input prompt 10 is equal to 1,000 tokens and the prefill 18 is equal to 1,000 tokens. The prefill 18 is divided into a plurality of prefill chunks 20, 22, 24, 26 (e.g., a first prefill chunk P1, a second prefill chunk P2, a third prefill chunk P3, and a fourth prefill chunk P4). The prefill chunks 20, 22, 24, 26 uniformly split the prefill 18 into smaller units of work (e.g., smaller tokens to process). For example, for a prefill 18 with 1,000 tokens, each prefill chunk 20, 22, 24, 26 includes 250 tokens. The number of prefill iterations is artificially increased by dividing the prefill 18 into multiple smaller units (the prefill chunks 20, 22, 24, 26). Instead of the LLM 106 performing a single prefill 18 iteration for the LLM inference, in the illustrated example, four prefill iterations occur using the plurality of prefill chunks 20, 22, 24, 26.

A prefill chunk size is determined for the prefill chunks 20, 22, 24, 26. In some implementations, for a given model-hardware combination (e.g., an LLM and a GPU pair), a onetime profiling of the prefill throughput of various chunk sizes occurs and a prefill chunk size is selected for expected workloads such that the end-to-end throughput of the LLM 106 is maximized on the GPU. In some implementations, the prefill chunk size is determined offline upon initialization of the LLM 106 on the GPU.

In some implementations, a ratio (P:D ratio) of the number of prefill tokens (P) to the number of decode tokens (D) in a given batch is computed and used to determine the prefill chunk size. For example, a P:D ratio of 10 implies that the number of prefill tokens is 10 times that of decode. For a fixed P+D, a lower value of P:D ratio means that there are more decode tokens in a batch compared to one with a higher value of P:D ratio.

The prefill chunk size impacts a number of decodes (tokens) that can be added (piggybacked) to the prefill chunk in a batch. For example, in a batch size of four requests (where one request is in the prefill phase and three are in the decode phase) and a chunk size of 128, a prefill of size P yields P/128 prefill-chunks, allowing P/128×3≈P/42 decodes to piggyback. Thus, in this case, when the P:D ratio is greater than 42, it allows overlapping of all decodes with prefills. Similarly, if the chunk size is 256, then all decodes can be piggybacked when the P:D ratio is greater than 84. A lower chunk size may help piggyback more decode tokens for a given prefill sequence. However, decoding time increases as the P:D ratio goes down.

The prefill chunk size is determined for each GPU and LLM 106 pair. Different prefill chunk sizes may be needed for different GPU and LLM model pairs. While four prefill chunks are illustrated, any number of prefill chunks may be selected. A greater number of prefill chunks (e.g., smaller prefill chunk size) allows more decodes to be processed with the prefill chunks. However, smaller prefill chunk sizes may affect prefill efficiency due to low GPU utilization while larger chunks retain GPU efficiency while allowing fewer decodes to piggyback on the prefill.

In some implementations, the prefill chunk size is selected for an LLM and GPU pair based on the expected P:D ratio and the split between prefill and decode times for a given application. In some implementations, the prefill chunk size is selected to ensure that that the sum of the prefill chunk size and the number of piggybacked decode tokens is a multiple of a tile size and the relevant matrix dimension of the fused operations stays a multiple of the tile size. For example, if the chosen prefill chunk size is 256, the tile size is 128, and the maximum permissible batch size is B, then, the prefill chunk size should be 256−(B−1).

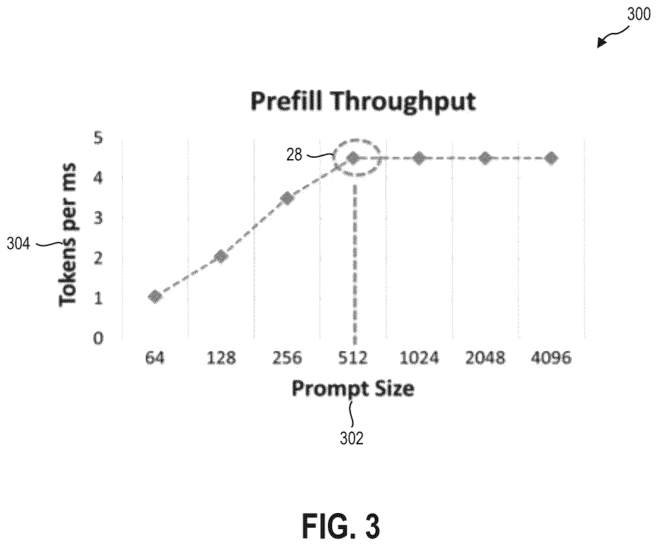

Referring now to FIG. 3, illustrated is an example graph 300 illustrating a prefill chunk size threshold 28 for a LLM (e.g., the LLM 106 (FIG. 1)) and GPU (e.g., the GPU pair. The graph 300 illustrates the prefill throughput for the LLM and GPU pair with tokens per millisecond on the y-axis 304 and the prompt size on the x-axis 302. The prefill chunk size threshold 28 illustrates a minimum prompt size where the prefill throughput on the GPU is constant and retains GPU efficiency. Selecting a prompt size to the left of the threshold (e.g., below 512) may lead to an inefficient use of the GPU. The prefill chunk size threshold 28 is determined for each LLM and GPU pair that is used to determine the prefill chunk size. In some implementations, the prefill chunk threshold 28 is determined by analyzing the prefill throughput of various chunk sizes for expected workloads using the LLM on the GPU and the prefill chunk size threshold 28 is used to determine the prefill chunk size for dividing the prefill 18 (FIG. 2) into prefill chunks 20, 22, 24, 26 (FIG. 2).

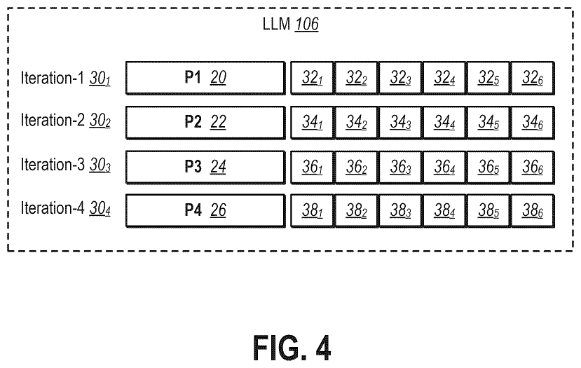

Referring now to FIG. 4, illustrated is an example of an LLM 106 using hybrid batches 30₁, 30₂, 30₃, 30₄ for LLM inference. Each hybrid batch includes a prefill chunk (e.g., prefill chunks 20, 22, 24, 26) and one or more decodes. The number of decodes fill the remaining space in the hybrid batch after the prefill chunk 20, 22, 24, 26.

In the illustrated example, the LLM 106 processes the hybrid batch 30₁ and the six decodes (e.g., decodes 32₁, 32₂, 32₃, 32₄, 32₅, 32₆) in the first iteration of the LLM 106, processes the hybrid batch 30₂ and the six decodes (e.g., decodes 34₁, 34₂, 34₃, 34₄, 34₅, 34₆) in the second iteration of the LLM 106, processes the hybrid batch 30₃ and the six decodes (e.g., decodes 36₁, 36₂, 36₃, 36₄, 36₅, 36₆) in the third iteration of the LLM 106, and processes the hybrid batch 30₄ and the six decodes (e.g., decodes 38₁, 38₂, 38₃, 38₄, 38₅, 38₆) in the fourth iteration of the LLM 106. The LLM 106 processes 24 decodes during the prefill by artificially increasing the prefill (e.g., the prefill 18 (FIG. 2)) into four prefill chunks 20, 22, 24, 26. Mixing the prefill and decode requests in a single hybrid batch enables uniformly high compute utilization in the GPU.

As the prefill chunk size changes, the number of decodes included in hybrid batch 30₁, 30₂, 30₃, 30₄ changes. For example, as the prefill chunk size increases, the number of decodes that can fit in the hybrid batch decreases, and as the prefill chunk size decreases, the number of decodes that can fit in the hybrid batch increases.

A maximum decode batch size to be piggybacked with a prefill chunk is determined for each LLM 106 and GPU pair. In some implementations, a maximum decode batch size to be piggybacked with a prefill chunk is determined based on the available GPU memory (M_{G}), the LLM 106's parameter memory requirement per GPU (M_{S}), and the maximum sequence length L that the LLM 106 supports. The total of prefill (P) and decode (D) tokens per request cannot exceed this maximum sequence length. An example equation 1 is illustrated for determining a maximum decode batch size B:

$$B = ⌊ ( \frac{{M}_{G} - {M}_{S}}{L * {m}_{kv}} ) ⌋ \qquad ( 1 )$$

where the memory required per pair of K and V for a token is mₖᵥ. The size of the hybrid batches 30₁, 30₂, 30₃, 30₄ is determined by combining the maximum decode batch size and the prefill chunk size. For example, the number of decodes is at most B−1 as the decodes piggyback along with one prefill chunk (the prefill's KV cache is in GPU memory until a corresponding decode iteration begins for the prefill).

Using hybrid batches 30₁, 30₂, 30₃, 30₄ eliminates a need to load model weights separately for decoding. Once the model weights for the LLM 106 are fetched for prefills (e.g., processing the prefill chunks 20, 22, 24, 26) the model weights are reused by the LLM 106 for processing the decodes that are added to the hybrid batches 30₁, 30₂, 30₃, 30₄. Using hybrid batches 30₁, 30₂, 30₃, 30₄ converts decoding from being in a memory-bound phase to being a compute-bound phase and decodes when piggybacked with prefills comes at a marginal cost and improve decode throughput.

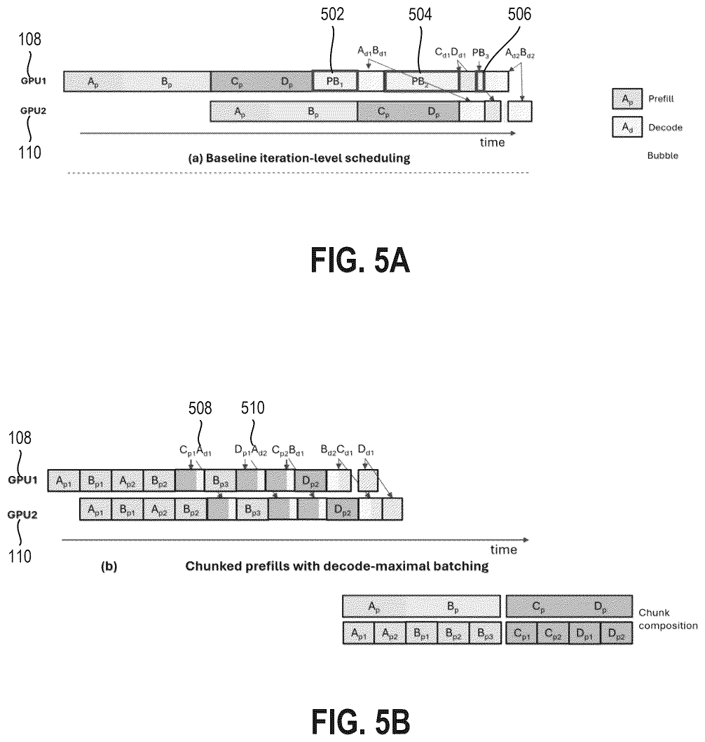

Referring now to FIG. 5A, illustrated is an example of scheduling prefills and decodes across multiple GPUs for LLM inference using pipeline parallelism. In the illustrated example, there are four requests (A, B, C, and D) (e.g., input prompts 10 (FIG. 1)) that are provided to the LLM (e.g., the LLM 106 (FIG. 1). Pipeline parallelism splits the LLM layer-wise, where each GPU is responsible for a subset of layers. Tensor parallelism shards each layer of the LLM across the participating GPUs.

The four input requests are scheduled across two GPUs 108, 110 (GPU 1 and GPU2) where a portion of the computation for the requests occurs on each GPU. The processing performed by the two GPUs are dependent upon one another. For example, the GPU2 110 starts processing a prefill for request A after the GPU1 108 performs the processing on request A and the GPU1 108 starts processing the decode for request A after the GPU2 110 completes the processing of the prefill for request A.

Pipeline bubbles commonly occur in the GPUs due to varying prompt and decode compute times. Pipeline bubbles are periods of GPU inactivity as subsequent pipeline stages wait for the completion of the corresponding micro-batch in the prior stages. Each iteration in LLM inference can require a different amount of compute (and consequently has varying execution times), depending on the composition of prefill and decode tokens. Three different types of pipelines bubbles may occur during LLM inference: (1) pipeline bubbles (e.g., PB1 502) that occur due to the varying number of prefill tokens in two consecutive micro-batches; (2) pipeline bubbles (e.g., PB2 504) that occur due to different compute times of prefill and decode stages when one is followed by the other; and (3) pipeline bubbles (e.g., PB3 506) that occur due to difference in decode compute times between micro-batches since the accumulated context length (KV cache length) varies across requests. Pipeline bubbles cause wasted GPU cycles and correspond to a loss in serving throughput with pipeline parallelism.

Referring now to FIG. 5B, illustrated is an example of scheduling prefill chunks of uniform size and hybrid batches across multiple GPUs (GPU1 108 and GPU 110) for LLM inference using pipeline parallelism. In the illustrated example, there are four requests (A, B, C, and D) (e.g., input prompts 10 (FIG. 1)) that are provided to the LLM (e.g., the LLM 106 (FIG. 1).

The four requests are of varying size and the prefill portion of the four requests A, B, C, and D are split into smaller prefill chunks of equal size. For example, request A is split into Aₚ₁ and Aₚ₂, request B is split into Bₚ₁, Bₚ₂, and Bₚ₃, request C is split into Cₚ₁, Cₚ₂, and request D is split into Dₚ₁ and Dₚ₂.

When the GPU2 110 is finished processing the prefill requests for A (Aₚ₁ and Aₚ₂), a hybrid batch 508 with a prefill for C (Cₚ₁) and a decode for A (A_{d1}) is provided to the GPU1 108. Another hybrid batch 510 with a prefill for D (Dpi) and a second decode for A (A_{d2}) is provided to the GPU1 108 to start processing the prefill for D while the GPU2 110 finishes processing the prefill chunks for C.

By providing hybrid batches (e.g., hybrid batches 508, 510) to the GPU1 108, the GPU1 108 can start processing decodes while the remaining prefills are processed by the GPU2 110. Moreover, the uniform compute design of the batches, significantly reduces pipeline bubbles in the GPU.

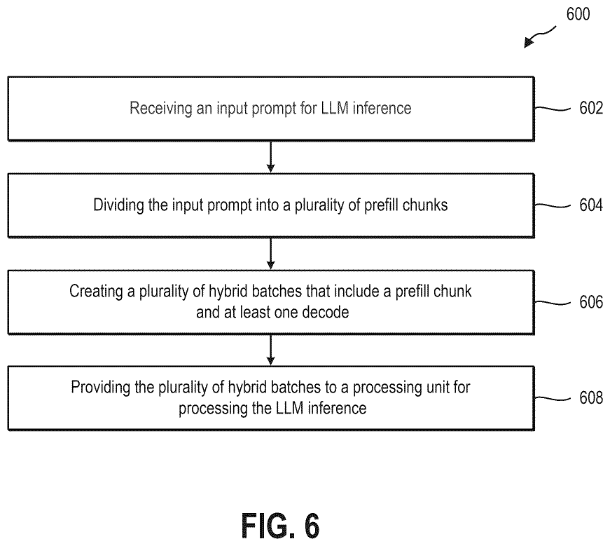

Referring now to FIG. 6, illustrated is an example method 600 for using hybrid batches (e.g., hybrid batches 30₁, 30₂, 30₃, 30₄ (FIG. 4) or hybrid batches 508, 510 (FIG. 5B)) for LLM inference. The actions of the method 600 are discussed below with reference to FIGS. 1-5B.

At 602, the method 600 includes receiving an input prompt for LLM inference. In some implementations, the LLM 106 receives the input prompt 10 for LLM inference from a user or a plurality of users. In some implementations, the LLM 106 receives a plurality of input prompts 10 for LLM inference. In some implementations, a plurality of LLMs receive the input prompt 10 for LLM inference from the user. In some implementations, a plurality of LLMs receive a plurality of input prompts 10 for LLM inference from a plurality of users.

At 604, the method 600 includes dividing the input prompt into a plurality of prefill chunks. The LLM 106 divides the input prompt 10 into a plurality of prefill chunks 20, 22, 24, 26. In some implementations, the prefill chunks 20, 22, 24, 26 are uniform in size. For example, the input prompt 10 is equal to 1,000 tokens and the prefill 18 is equal to 1,000 tokens. The prefill 18 is divided into a plurality of prefill chunks 20, 22, 24, 26 where each prefill chunk includes 250 tokens. The number of prefill iterations is artificially increased by dividing the prefill 18 into multiple smaller units (the prefill chunks 20, 22, 24, 26).

The LLM 106 receives a prefill chunk size and uses the prefill chunk size to divide the input prompt 10 into the plurality of prefill chunks 20, 22, 24, 26. Each prefill chunk is equal to the prefill chunk size. The prefill chunk size impacts a number of decodes (tokens) that can be added (piggybacked) to the prefill chunk in a batch. A smaller prefill chunk size allows more decodes to be processed with the prefill chunks while a larger prefill chunk size allows less decodes to be processed with the prefill chunks. The prefill chunk size is determined for each processing unit (e.g., the GPUs 108, 110) and LLM 106 pair. Different prefill chunk sizes may be needed for different processing units and LLM model pairs.

In some implementations, a ratio of the number of prefill tokens (P) to the number of decode tokens (D) in a given batch is computed and used to determine the prefill chunk size. In some implementations, the prefill chunk size is selected for the LLM 106 and a processing unit (e.g., the GPU1 108 or the GPU2 110) pair using an expected prefill to decode ratio and an expected prefill and decode time for an application. In some implementations, the prefill chunk size is determined by selecting the prefill chunk size at a prefill chunk size threshold 28 for a minimum input prompt size where a prefill throughput on the processing unit (e.g., the GPU1 108 or the GPU2 110) is constant.

In some implementations, the prefill chunk size is selected in response to analyzing the prefill throughput of various chunk sizes for expected workloads using the LLM 106 on the processing unit (e.g., the GPU1 108 or the GPU2 110) and a prefill chunk size is selected for expected workloads such that the end-to-end throughput of the LLM 106 is maximized on the processing unit (e.g., the GPU1 108 or the GPU2 110). The prefill chunk size is provided to the LLM 106 as a configuration parameter. For example, the prefill chunk size is determined offline and provided as a configuration parameter for the LLM 106 upon loading the LLM 106.

At 606, the method 600 includes creating a plurality of hybrid batches that include a prefill chunk and at least one decode. The LLM 106 uses decode-maximal batching to construct a hybrid batch (hybrid batches 30₁, 30₂, 30₃, 30₄ or hybrid batches 508, 510) by using a single prefill chunk (prefill chunks 20, 22, 24, 26) and filling the remaining batch with decodes (decodes 32₁, 32₂, 32₃, 32₄, 32₅, 32₆, decodes 34₁, 34₂, 34₃, 34₄, 34₅, 34₆, decodes 36₁, 36₂, 36₃, 36₄, 36₅, 36₆, 38₁, 38₂, 38₃, 38₄, 38₅, 38₆). Each hybrid batch includes a prefill chunk (e.g., prefill chunks 20, 22, 24, 26) and at least one decode. The hybrid batches provide units of work that are both compute saturating and have a uniform compute requirement.

In some implementations, a size for each hybrid batch (hybrid batches 30₁, 30₂, 30₃, 30₄ or hybrid batches 508, 510) is determined based on a prefill chunk size and a maximum decode batch size for a number of decodes to include in each hybrid batch. The maximum decode batch size for a number of decodes to be added to a prefill chunk (prefill chunks 20, 22, 24, 26) is determined based on available processing unit memory, a parameter requirement for the LLM, and a maximum sequence length supported by the LLM. The total of prefill and decode tokens per request cannot exceed this maximum sequence length. In some implementations, the size of the hybrid batches (hybrid batches 30₁, 30₂, 30₃, 30₄ or hybrid batches 508, 510) is determined by combining the maximum decode batch size and the prefill chunk size.

At 608, the method 600 includes providing the plurality of hybrid batches to a processing unit for processing the LLM inference. In some implementations, the processing unit is one or more GPUs (e.g., the GPU1 108 or the GPU2 110). The LLM 106 provides the plurality of hybrid batches (hybrid batches 30₁, 30₂, 30₃, 30₄ or hybrid batches 508, 510) to the GPU (the GPU1 108 or the GPU2 110) for processing. The LLM 106 provides a hybrid batch to the GPU for processing during each iteration of the LLM 106. For example, during a first iteration of the LLM 106, a first hybrid batch (hybrid batch 30₁) is sent to the GPU (the GPU1 108 or the GPU2 110) for processing and during a second iteration of the LLM, a second hybrid batch (hybrid batch 30₂) is sent to the GPU (the GPU1 108 or the GPU2 110) for processing until all of the hybrid batches are processed by the GPU.

In some implementations, the LLM 106 provides the plurality of hybrid batches (hybrid batches 30₁, 30₂, 30₃, 30₄ or hybrid batches 508, 510) to a plurality of GPUs (the GPU1 108 and the GPU2 110) for processing the LLM inference. Each GPU processes a portion of the LLM inference. In some implementations, the LLM 106 uses pipeline parallelism or tensor parallelism to schedule the plurality of hybrid batches across the plurality of GPUs. By providing hybrid batches of uniform compute design to the plurality of GPUs significantly reduces pipeline bubbles in the GPUs.

In some implementations, the processing unit is a central processing unit (CPU) and the LLM 106 provides the plurality of hybrid batches (hybrid batches 30₁, 30₂, 30₃, 30₄ or hybrid batches 508, 510) to the CPU for processing. In some implementations, the processing unit is an Application Specific Integrated Circuit (ASIC) and the LLM 106 provides the plurality of hybrid batches (hybrid batches 30₁, 30₂, 30₃, 30₄ or hybrid batches 508, 510) to the ASIC for processing.

The method 600 improves LLM inference performance. The method 600 uses decode-maximal batching to improve processing unit utilization by combining decodes with prefills, which converts the memory-bound decode phase to be compute bound. Chunked-prefills helps with making more prefills available for decodes to piggyback, and also provides for a uniform unit of work which helps significantly reduce pipeline bubbles.

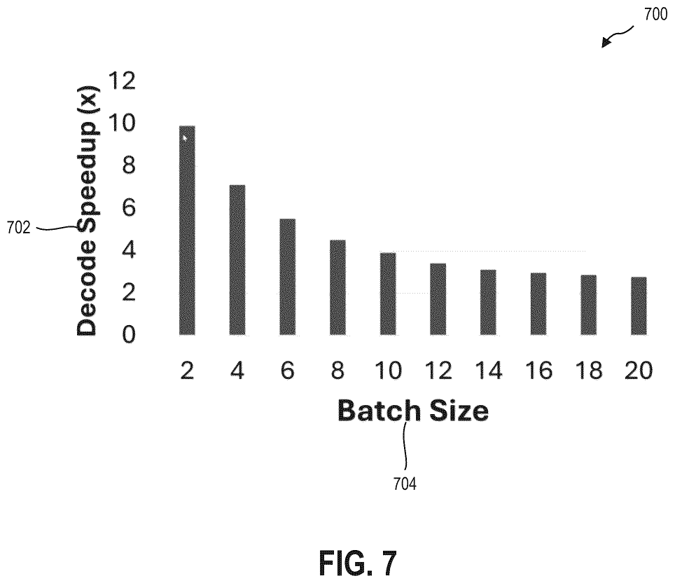

Referring now to FIG. 7, illustrated is an example graph 700 illustrating a speedup in decode processing for different batch sizes using hybrid batches (e.g., hybrid batches 30₁, 30₂, 30₃, 30₄ (FIG. 4) or hybrid batches 508, 510 (FIG. 5B)). For example, the graph 700 illustrates a speedup for decode processing for a chunk size of 256 for LlaMa-13B on A6000 GPU. The graph 700 includes a y-axis 702 illustrating a decode speedup for a batch size on the x-axis 704. For example, an LLM (e.g., the LLM 106) with a batch size of 2 can see a speedup of around ten times for decodes when using hybrid batches. The decode throughput is higher due to decode-maximal batching that computes decode tokens with matrix-multiplications, allowing reuse of the LLM's model weights for both prefills and decodes once the model weights are fetched from the GPU's global memory.

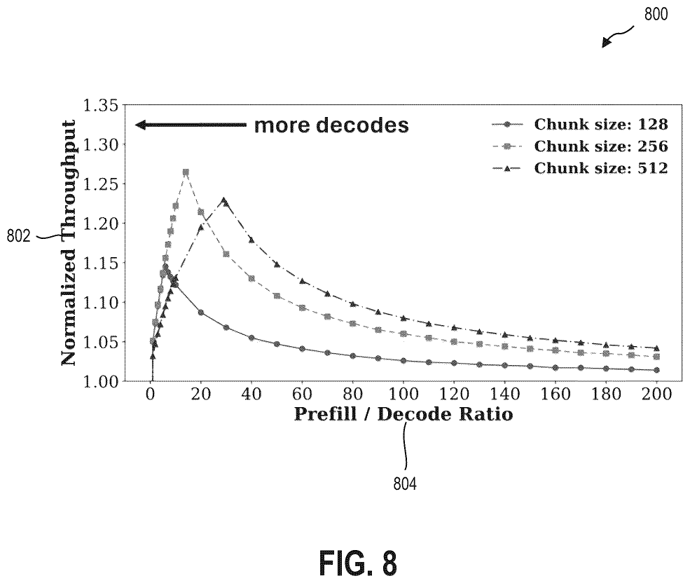

Referring now to FIG. 8, illustrated is an example graph 800 illustrating an increase in throughput when using hybrid batches (e.g., hybrid batches 30₁, 30₂, 30₃, 30₄ (FIG. 4) or hybrid batches 508, 510 (FIG. 5B)) for LLM inference. The graph 800 illustrates varying prefill (P) to decode (D) ratios (P:D ratio) on the end-to-end inference throughput using various sequence lengths and chunk sizes. A peak efficiency of throughput occurs at different P:D ratios for different prefill chunk size and batch size scenarios. If C is the chunk size and B is the batch size, the peak occurs when the decodes perfectly piggyback with the prefill chunks when the number of prefill chunks (=P/C) is the same as the required number of decode iterations (=D/(B−1)) (i.e., when P:D=C/(B−1).

For example, using a chunk size of 256 at batch size of 18, the peak throughput improvement of 1.27× is achieved at P:D=14 (≈C/(B−1)=256/17) for sequence length of 1K, as illustrated in the graph 800. Using the chunk size of 512 for sequence length=1K at batch size of 18 also provides significant gains of up to 1.23× at P:D=28 (≈C/(B−1)=512/17) whereas the gains are much lower with a chunk size of 128.

While smaller chunks provide more opportunity to overlap decodes, splitting prefills into very small chunks leads to lower arithmetic intensity (e.g., less efficient matmuls and higher overheads (due to multiple reads of KV cache), resulting in reduced end-to-end performance. A much higher throughput is obtained with chunk size of 256/512 compared to the smaller chunk size of 128. Peak gains occur at a higher value of P:D ratio when using a larger chunk size. When the P:D ratio is balanced, and the LLM inference is not entirely dominated by either prefills or decodes, an improvement in performance (end-to-end throughput) is achieved by allowing an overlap in prefills and decodes efficiently for longer.

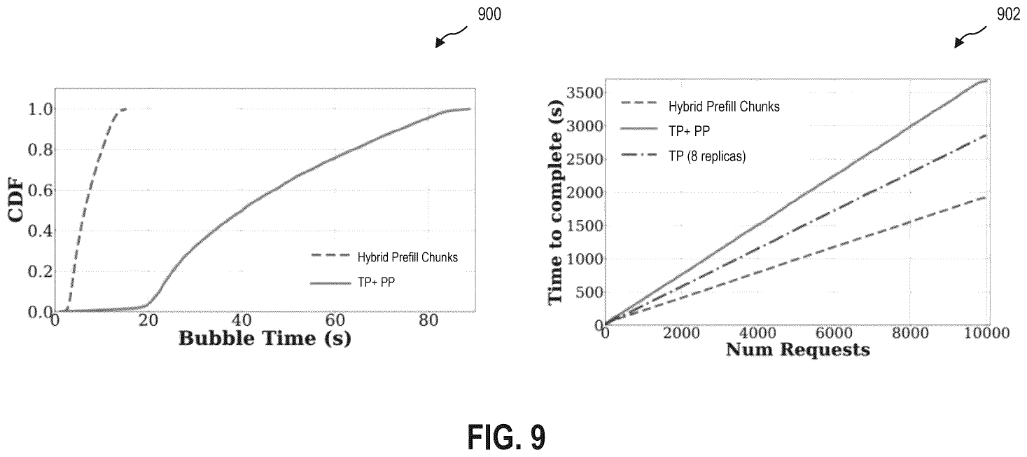

FIG. 9 illustrates example graphs 900 and 902 illustrating a reduction in pipeline bubbles when using hybrid batches of uniform size (e.g., hybrid batches 30₁, 30₂, 30₃, 30₄ (FIG. 4) or hybrid batches 508, 510 (FIG. 5B)) and pipeline parallelism across multiple GPUs (e.g., GPU1 108, GPU2 110 (FIG. 5B). The graph 900 illustrates a comparison of bubble times on the GPUs between using hybrid batches and pipeline parallelism for GPT-3 deployed on DGX A100(s) in simulation as compared to existing solutions. The graph 900 illustrates the pipeline bubble time per request. The graph 900 illustrates using hybrid batches and pipeline parallelism causes a reduction in the median pipeline bubble time per request by 6.29× by creating equal-compute units of work as compared to existing solutions.

The graph 902 illustrates an end-to-end completion time of using hybrid batches and pipeline parallelism for GPT-3 deployed on DGX A100(s) in simulation as compared to existing solutions. The graph 902 plots the time to complete a given number of requests. Using hybrid batches and pipeline parallelism requires less memory for storing parameters compared to existing solutions, resulting in more room for the KV cache. The graph 902 illustrates that using hybrid batches and pipeline parallelism supports a 2.45× higher batch size compared to existing solutions and is accelerated by 1.91× compared to the existing solutions.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving, at a large language model (LLM), an input prompt for LLM inference;
dividing the input prompt into a plurality of prefill chunks;
creating a plurality of hybrid batches, wherein each hybrid batch includes a prefill chunk and at least one decode; and
providing the plurality of hybrid batches to a processing unit for processing the LLM inference.

2. The method of claim 1, further comprising:
receiving a prefill chunk size; and
using the prefill chunk size to divide the input prompt into the plurality of prefill chunks, wherein each prefill chunk is equal to the prefill chunk size.

3. The method of claim 2, wherein the prefill chunk size is selected for the LLM and the processing unit using an expected prefill to decode ratio and an expected prefill and decode time for an application.

4. The method of claim 2, wherein the prefill chunk size is determined by selecting the prefill chunk size at a prefill chunk size threshold for a minimum input prompt size where a prefill throughput on the processing unit is constant.

5. The method of claim 2, wherein the prefill chunk size is selected in response to analyzing a prefill throughput of various chunk sizes for expected workloads using the LLM on the processing unit and the prefill chunk size is provided to the LLM as a configuration parameter.

6. The method of claim 1, further comprising:
determining a size for each hybrid batch based on a prefill chunk size and a maximum decode batch size for a number of decodes to include in each hybrid batch, wherein the size for each hybrid batch is uniform.

7. The method of claim 6, wherein the maximum decode batch size is determined based on available processing unit memory, a parameter requirement for the LLM, and a maximum sequence length supported by the LLM.

8. The method of claim 1, wherein the processing unit is one of a central processing unit (CPU), a graphics processing unit (GPU), or an Application Specific Integrated Circuit (ASIC).

9. The method of claim 1, further comprising:
Providing the plurality of hybrid batches to a plurality of graphics processing units (GPUs) for processing the LLM inference, where each GPU of the plurality of GPUs processes a portion of the LLM inference.

10. The method of claim 9, further comprising:
using pipeline parallelism or tensor parallelism to schedule the plurality of hybrid batches across the plurality of GPUs.

11. A computing device, comprising:
a memory to store data and instructions; and
a processor operable to communicate with the memory, wherein the processor is operable to:
receive, at a large language model (LLM), an input prompt for LLM inference;
divide the input prompt into a plurality of prefill chunks;
create a plurality of hybrid batches, wherein each hybrid batch includes a prefill chunk and at least one decode; and
provide the plurality of hybrid batches to a processing unit for processing the LLM inference.

12. The computing device of claim 11, wherein the processor is further operable to:
receive a prefill chunk size; and
use the prefill chunk size to divide the input prompt into the plurality of prefill chunks, wherein each prefill chunk is equal to the prefill chunk size.

13. The computing device of claim 12, wherein the prefill chunk size is selected for the LLM and the processing unit using an expected prefill to decode ratio and an expected prefill and decode time for an application.

14. The computing device of claim 12, wherein the prefill chunk size is determined by selecting the prefill chunk size at a prefill chunk size threshold for a minimum input prompt size where a prefill throughput on the processing unit is constant.

15. The computing device of claim 12, wherein the prefill chunk size is selected in response to analyzing a prefill throughput of various chunk sizes for expected workloads using the LLM on the processing unit and the prefill chunk size is provided to the LLM as a configuration parameter.

16. The computing device of claim 11, wherein the processor is further operable to determine a size for each hybrid batch based on a prefill chunk size and a maximum decode batch size for a number of decodes to include in each hybrid batch, wherein the size for each hybrid batch is uniform.

17. The computing device of claim 16, wherein the maximum decode batch size is determined based on available processing unit memory, a parameter requirement for the LLM, and a maximum sequence length supported by the LLM.

18. The computing device of claim 16, wherein the processing unit is one of a central processing unit (CPU), a graphics processing unit (GPU), or a Application Specific Integrated Circuit (ASIC).

19. The computing device of claim 11, wherein the processor is further operable to provide the plurality of hybrid batches to a plurality of graphics processing units (GPUs) for processing the LLM inference, where each GPU of the plurality of GPUs processes a portion of the LLM inference.

20. The computing device of claim 19, wherein the processor is further operable to use pipeline parallelism or tensor parallelism to schedule the plurality of hybrid batches across the plurality of GPUs.
